(19) United States
(12) Patent Application Publication
(10) Pub. No.: US 2023/0216814 A1
(43) Pub. Date: Jul. 6, 2023

(54) METHOD AND APPARATUS FOR MANAGING ABUSING MESSAGE BASED ON INTERFACE

(71) Applicant: KAKAO CORP., Jeju-si (KR)

(72) Inventors: Soo Bum KIM, Seongnam-si (KR); Jung Woo CHOI, Seongnam-si (KR); Min Jeong KIM, Seongnam-si (KR); Keun Seop LEE, Seongnam-si (KR); Chang Yong LEE, Seongnam-si (KR)

(21) Appl. No.: 18/091,386

(22) Filed: Dec. 30, 2022

(30) Foreign Application Priority Data
Dec. 31, 2021 (KR) 10-2021-0194307

(51) Int. Cl. H04L 51/063; H04L 51/212; G06F 3/0482

(52) U.S. Cl. CPC H04L 51/063; H04L 51/212; G06F 3/0482

(57) ABSTRACT

Provided are a method and apparatus for managing an abusing message based on an interface. The method of managing the abusing message includes storing at least one of a rule set and a spam keyword for an abusing message, receiving a new message transmitted to an anonymous chatroom, determining the new message as the abusing message based on the at least one of the rule set and the spam keyword, and hiding the abusing message in a chat window. The administrator terminal is configured to set activation of a function for hiding the abusing message through an interface distinguished from the chat window.

### CROSS-REFERENCE TO RELATED APPLICATION

This application claims the benefit of Korean Patent Application No. 10-2021-0194307 filed on Dec. 31, 2021, in the Korean Intellectual Property Office, the entire disclosure of which is incorporated herein by reference for all purposes.

### BACKGROUND

### 1. Field of the Invention

One or more embodiments relate to a method and apparatus for managing an abusing message based on an interface.

### 2. Description of the Related Art

Recently, there is an increase in the use of an anonymous chatroom which allows people to chat online with someone who is not even in a friend relationship. An anonymous chatroom, in which a chat message may be exchanged among users not in a friend relationship, is being widely used since the anonymous chatroom may be generated for various topics and be easily accessible.

However, since many and unspecified users who do not know each other may access the anonymous chatroom, there are often cases where some people join the anonymous chatroom to advertise or input a message including sexual expressions, swear words, and the like, during chatting. Therefore, a service agent operating the anonymous chatroom needs to prepare countermeasures against various abusing messages.

### SUMMARY

Embodiments provide a rule set to an administrator terminal or allow a key word for filtering an abusing message to be registered, thus providing a method and apparatus for effectively processing an abusing message displayed in an anonymous chatroom.

Embodiments propose a method and apparatus for providing convenient management of an abusing message by providing an option for an administrator terminal to process the abusing message in various manners through an interface.

Embodiments propose a method and apparatus for enabling a user terminal to recognize non-exposure of an abusing message by hiding the abusing message of an anonymous chatroom in various manners.

According to an aspect, there is provided a method of managing an abusing message, performed by an administrator terminal, the method including storing at least one of a rule set and a spam keyword for an abusing message, receiving a new message transmitted to an anonymous chatroom, determining the new message as the abusing message based on the at least one of the rule set and the spam keyword, and hiding the abusing message in a chat window. The administrator terminal may be configured to set activation of a function for hiding the abusing message through an interface distinguished from the chat window.

The hiding of the abusing message may include hiding all details of the abusing message matching the at least one of the spam keyword and the rule set, or hiding some details of the abusing message matching the at least one of the spam keyword and the rule set.

The hiding of the abusing message may include not displaying all the details of the abusing message in a speech bubble while displaying the speech bubble of the abusing message; displaying an announcement about the hiding of the abusing message, which replaces all the details of the abusing message in the speech bubble, while displaying the speech bubble of the abusing message; or displaying an object indicating the hiding of the abusing message without displaying the speech bubble of the abusing message.

The interface may display, on one common area or on areas distinguished from one another, the abusing message filtered according to the at least one of the rule set and the spam keyword.

The interface may provide a menu that enables the administrator terminal to cancel the hiding of the abusing message filtered according to the at least one of the rule set and the spam keyword and thus hidden.

The administrator terminal may receive the rule set classified according to a filtering intensity or receives a filtering intensity rule related to a combination of rules included in the rule set.

When the new message is determined to be the abusing message and thus is hidden, the hiding of the abusing message may be canceled through filing an objection to the abusing message.

According to another aspect, there is provided an administrator terminal including a processor. The processor may be configured to store a rule set or a spam keyword for an abusing message, receive anew message transmitted to an anonymous chatroom and, when the new message is determined to be the abusing message based on the at least one of the rule set and the spam keyword, hide the abusing message in a chat window. The administrator terminal may be configured to set activation of a function for hiding the abusing message through an interface distinguished from the chat window.

The processor may be configured to hide all details of the abusing message matching the at least one of the spam keyword and the rule set, or hide some details of the abusing message matching the at least one of the spam keyword and the rule set.

The processor may be configured to not display all the details of the abusing message in a speech bubble while displaying the speech bubble of the abusing message, display an announcement about the hiding of the abusing message, which replaces all the details of the abusing message in the speech bubble, while displaying the speech bubble of the abusing message, or display an object indicating the hiding of the abusing message without displaying the speech bubble of the abusing message.

The interface may be configured to display, on one common area or on areas distinguished from one another, the abusing message filtered according to the at least one of the rule set and the spam keyword.

The interface may be configured to provide a menu that enables the administrator terminal to cancel the hiding of the abusing message filtered according to the at least one of the rule set and the spam keyword and thus hidden.

The administrator terminal may receive the rule set classified according to a filtering intensity or receive a filtering intensity rule related to a combination of rules included in the rule set.

When the new message is determined to be the abusing message and thus is hidden, the hiding of the abusing message may be canceled through filing an objection to the abusing message.

Additional aspects of embodiments will be set forth in part in the description which follows and, in part, will be apparent from the description, or may be learned by practice of the disclosure.

According to embodiments, a rule set may be provided to an administrator terminal in an anonymous chatroom or a keyword for filtering the abusing message may be registered, so that the abusing message displayed in the anonymous chatroom may be effectively hidden.

According to embodiments, options for an administrator terminal to process an abusing message through an interface may be provided in various manners in order to provide convenience for managing the abusing message.

According to embodiments, an abusing message in an anonymous chatroom may be hidden in various manners, so that a user terminal may recognize the non-exposure of the abusing message.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a method of managing an abusing message, according to an embodiment;

FIG. 2 is a diagram illustrating an example of a rule set and a spam keyword, according to an embodiment;

FIG. 3 is a diagram illustrating an interface providing a function activation for managing an abusing message, according to an embodiment;

FIGS. 4A and 4B are diagrams illustrating an example of hiding an abusing message according to an embodiment;

FIGS. 5A and 5B are diagrams illustrating a result of a hiding process distinguished according to a rule set and a spam keyword, according to an embodiment;

FIGS. 6A and 6B are diagrams illustrating an example of an abusing terminal transmitting an abusing message and an interface for managing the abusing message, according to an embodiment;

FIGS. 7A and 7B are diagrams illustrating an example of an interface for managing an abusing message, according to an embodiment;

FIGS. 8A and 8B are diagrams illustrating an example of a request for an objection to a hidden abusing message, according to an embodiment; and

FIG. 9 is a diagram illustrating an interface for adjusting a filtering intensity for an abusing message, according to an embodiment.

### DETAILED DESCRIPTION

Hereinafter, embodiments will be described in detail with reference to the accompanying drawings. The scope of the right, however, should not be construed as limited to the embodiments set forth herein. In the drawings, like reference numerals are used for like elements.

Various modifications may be made to the embodiments. Here, the embodiments are not construed as limited to the disclosure and should be understood to include all changes, equivalents, and replacements within the idea and the technical scope of the disclosure.

Although terms of “first” or “second” are used to explain various components, the components are not limited to the terms. These terms should be used only to distinguish one component from another component. For example, a first component may be referred to as a second component, and similarly the second component may also be referred to as the first component.

The terminology used herein is for the purpose of describing particular embodiments only and is not to be limiting of the embodiments. As used herein, the singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

Hereinafter, embodiments will be described in detail with reference to the accompanying drawings.

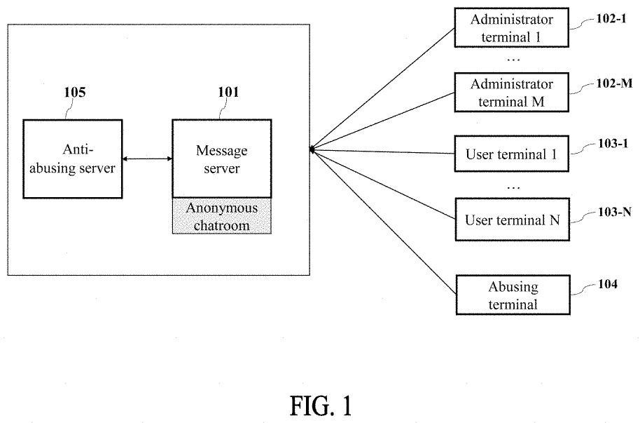

FIG. 1 is a diagram illustrating a method of processing an abusing message, according to an embodiment.

Referring to FIG. 1, an administrator terminal 102 may generate an anonymous chatroom through a message server 101. Similar to Kakao's Open Chat® (Open Chat is a unique trademark of Kakao) service, the anonymous chatroom may allow a user to set their unique profile or another profile generated for the anonymous chatroom and to exchange a message with those not in a friend relationship. The anonymous chatroom may be accessed through an external link and be used for many users to exchange opinions on various topics.

Referring to FIG. 1, M number of administrator terminals from a terminal administrator (administrator 1) 102-1 to a terminal administrator (terminal administrator M) 102-M may manage the anonymous chatroom. In this case, among the administrator terminals from the administrator terminal 102-1 to the administrator terminal 102-M, an administrator terminal corresponding to a host in the anonymous chatroom may generate the anonymous chatroom first, edit or delete the anonymous chatroom, or delegate the authority of managing the anonymous chatroom. Among the administrator terminal 102-1 to administrator terminals 102-M, an administrator terminal that has been entrusted the authority to manage the anonymous chatroom by the administrator terminal corresponding to the host may be an administrator terminal corresponding to a vice-host.

N number of user terminals 103-1 to 103-N may enter the anonymous chatroom by logging in to the anonymous chatroom with an account registered in a message application through the link of the anonymous chatroom. Herein, an abusing terminal 104 may refer to a terminal that transmits an abusing message, among the user terminals 103-1 to 103-N. In the anonymous chatroom, there may be one or more abusing terminals 104.

Hereinafter, the operation of one user terminal 103, which is any one of the N number of user terminals 103-1 to 103-N, is described. Similarly, one administrator terminal 102, which is any one of the M number of administrator terminals 102-1 to 102-M, is described.

Referring to FIG. 1, the message server 101 may manage the anonymous chatroom and process messages transmitted and received in the anonymous chatroom. According to one embodiment of the present invention, when the administrator terminal 102 logs in with an account registered in the message application or logs in with the account of the message application, and then the administrator terminal 102 enters the anonymous chat room, the administrator terminal 102), the ruleset may be transmitted. In this case, the rule set may include rules updated to the latest version. In addition, when the user terminal 103 is changed to a host or a vice-host in the anonymous chatroom and thus becomes the administrator terminal 102, the rule set may be provided to the user terminal 103.

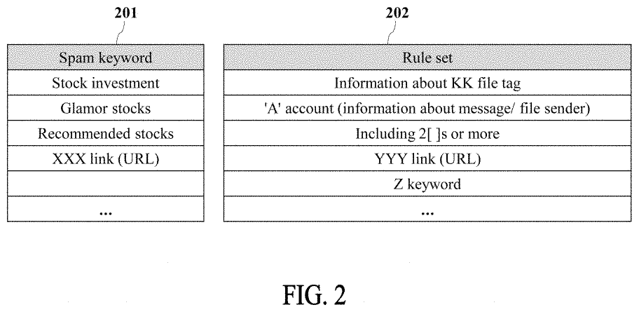

According to an embodiment, as shown in FIG. 2, when the administrator terminal 102 logs in to the message application or enters the anonymous chatroom, the message server 101 may transmit the rule set to the administrator terminal 102. That is, the message server 101 may serve as an anti-abusing server 105.

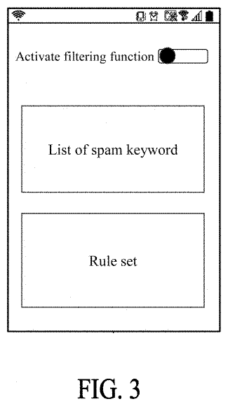

According to another embodiment, as shown in FIG. 3, when the administrator terminal 102 logs in to the message application or enters the anonymous chatroom, the anti-abusing server 105, which is distinguished from the message server 101, may transmit the rule set to the administrator terminal 102.

That is, according to the present disclosure, the message server 101 may function as the anti-abusing server 105 to provide the rule set to the administrator terminal 102, or the message server 101 may be separated from the anti-abusing server 105, so that the anti-abusing server 105 may provide the rule set to the administrator terminal 102.

In addition, according to an embodiment, the message server 101 may provide the rule set to the administrator terminal 102 and transmit a command to hide the abusing message to the administrator terminal 102 and the user terminal 103 joining the anonymous chatroom. According to another embodiment, the abusing terminal 105 may provide the rule set to the administrator terminal 102 and transmit the command to hide the abusing message to the administrator terminal 102 and the user terminal 103 joining the anonymous chatroom. According to another embodiment, the abusing terminal 105 may provide the rule set to the administrator terminal 102 and transmit, through the message server 101, the command to hide the abusing message to the administrator terminal 102 and the user terminal 103 joining the anonymous chatroom.

According to an embodiment, the rule set that the message server 101 or the anti-abusing server 105 provides to the administrator terminal 102 may be used to determine whether a new message transmitted by the abusing terminal 104 is an abusing message. Separately, the administrator terminal 102 may directly register a spam keyword for determining whether a message is an abusing message.

For example, the rule set may be information including at least one of a keyword, a URL, a message identifier, a file identifier, information about file tag, information about a message sender, and information about a file sender that require to be managed as spam. The rule set may be generated based on the report of the user terminal 103 or the administrator terminal 102, which is using the message service, or may be generated by the arbitrary designation of a system manager associated with the message server 101. In addition, the spam keyword registered by the administrator terminal 102 may be transmitted to the anti-abusing server 105 or the message server 101, in which case the rule set may be generated based on the spam keyword transmitted to the anti-abusing server 105 or the message server 101.

The rule set may be managed in N number by the message server 101 or the anti-abusing server 105. When the administrator terminal 102 activates the message application working with the message server 101 or logs in to the account registered in the messenger application, the administrator terminal 102 may receive the latest rule set from the message server 101 or the anti-abusing server 105, when the administrator terminal 102 enters the anonymous chatroom.

Then, the administrator terminal 102 may determine whether a new message transmitted by the abusing terminal 104 is an abusing message by using at least one of the rule set and the spam keyword. The new message may be a text, a file (e.g., a still image, a video, and the like), or a URL. When the new message transmitted by the abusing terminal 104 is determined to be an abusing message, the administrator terminal 102 may transmit, to the message server 101 or the anti-abusing server 105, a request for hiding the new message.

The message server 101 or the anti-abusing server 105 may transmit a command to hide the new message determined to be the abusing message to the administrator terminal 102 and the user terminal 103, which are clients. Then, the administrator terminal 102 and the user terminal 103 may hide the new message determined to be the abusing message.

For example, the hiding of a message may refer to not displaying all contents included in the message or hiding specific contents (keywords or phrases) matching at least one of the rule set and the spam keyword, among all contents included in the message. Alternatively, the hiding of a message may include a case in which the message is displayed but overlapped by a certain object, so that the administrator terminal 102 or the user terminal 103 may not identify all the contents of the message. Also, the hiding of the message may include deleting the message itself. In this case, when the hiding of the message is performed by deleting the message, the administrator terminal 102 or the user terminal 103 may display an announcement that the message has been hidden as a display method, such as a rich feed.

In addition, the hiding of the message may include deleting a still image included in the message or transforming the still image so as not to be recognized (for example, mosaic processing). Alternatively, the hiding of the message may include deleting a video included in the message or preventing the video from being played.

FIG. 2 is a diagram illustrating an example of a rule set and a spam keyword, according to an embodiment.

Referring to FIG. 2, an example of a spam keyword 201 and a rule set 202 is shown. The spam keyword 201 may refer to a keyword input by an administrator terminal 102 of an anonymous chatroom, so that the administrator terminal 102 may determine whether a new message transmitted to the anonymous chatroom is an abusing message.

The spam keyword 201 shown in FIG. 2 may include a keyword and a URL registered by the administrator terminal 102. The spam keyword 201 may be applied to all anonymous chatrooms in which the administrator terminal 102 is registered as an administrator or applied to some anonymous chatrooms designated by the administrator terminal 102. The spam keyword 201 registered by the administrator terminal 102 may be transmitted to the anti-abusing server 105. Then, the anti-abusing server 105 may generate the rule set 202 based on the spam keyword 201.

In addition, the rule set 202 of the latest version may be provided to the administrator terminal 102 when the administrator terminal 102 logs in to an account registered in the message server 101 through a chat application or enters an anonymous chatroom. The rule set 202 may be provided by the message server 101 as described with reference to FIG. 2 or by the anti-abusing server 105 as described with reference to FIG. 3. The rule set 202 may refer to information including at least one of a URL, a keyword, a message identifier, a file identifier, information about file tag, information about a message sender, and information about a file sender that require to be managed as spam. In addition, the rule set 202 may include an identifier or tag information of media content, such as images, videos, symbols, and emoticons.

The rule set 202 may be a rule set that is collectively applied to all anonymous chatrooms registered in the message server 101, a rule set that is managed in units of a property or a category of an anonymous chatroom, or a rule set that is managed in units of an anonymous chatroom.

When a new message transferred to the anonymous chatroom matches a specific rule defined in the rule set 202, the new message may be determined to be an abusing message. The rule set 202 may be generated by the report of the administrator terminal 102 or the user terminal 103 that is using the message service, or by arbitrary designation of a system manager related to the message server 101. The rule set 202 may be managed in N number in units of anonymous chatrooms. The rule set 202 may be newly created each time or updated.

In addition, when the user terminal 103 that has entered the anonymous chatroom changes to a host or a vice-host in the anonymous chatroom and thus becomes the administrator terminal 102, the message server 101 or the anti-abusing server 105 may transmit the rule set 202 of the latest version to the user terminal 103 which changes to the administrator terminal 102.

The rule set 202 may be managed in the message server 101 differently according to the subject or category of an anonymous chatroom. Since the user terminal 103 that is not in a friend relationship and in a non-acquaintance relationship with many of the participants may join the anonymous chatroom according to a specific topic, a rule set may be also provided differently, according to the subject or category, from the rule set by the administrator terminal 102 when the anonymous chatroom is generated.

Alternatively, the rule set 202 may be divided into a basic rule and a feature rule for management. The basic rule may be commonly applicable regardless of the subject or category of the anonymous chatroom, such as profanity, sexual expression, advertisement, and the like, and the feature rule may include a rule related to the subject or category of the anonymous chatroom.

In another example, when the abusing terminal 104 joining an anonymous chatroom transmits a new message to the message server 101, the message server 101 may transmit the new message to the administrator terminal 102 corresponding to the host or vice-host in the anonymous chatroom. Then, the administrator terminal 102 may determine whether the new message transmitted by the abusing terminal 104 is an abusing message, based on the rule set 202 provided by the message server 101 or the anti-abusing server 105 or the spam keyword directly registered by the administrator terminal 102.

Alternatively, when the new message is determined to be an abusing message, the administrator terminal 102 may transmit a request for hiding the new message to the message server 101 or the anti-abusing server 105. In response to the request for hiding the new message, the message server 101 or the anti-abusing server 105 may transmit a command to hide the new message to the administrator terminal 102 and the user terminal 103. For example, the command to hide the new message may be a command for the administrator terminal 102 to hide the new message or cancel the hiding of the new message. However, the command to hide the new message may be a command for the user terminal 103 to hide the new message but not to cancel the hiding of the new message.

For example, the administrator terminal 102 may transmit the log ID of the new message or the log ID of a media file, which is a target of the request for hiding, to the message server 101 or the anti-abusing server 105.

When the new message transmitted by the abusing terminal 104 is determined to be an abusing message according to the spam keyword 201 or the rule set 202 shown in FIG. 2, the new message may be hidden.

For example, the hiding of the message may refer to not displaying all contents included in the message or hiding specific contents (keywords or phrases) matching at least one of the rule set and the spam keyword, among all contents included in the message. Alternatively, the hiding of the message may include a case in which the message is displayed but overlapped by a certain object to prevent all the contents of the message from being identified. In addition, the hiding of the message may include deleting a still image included in the message or transforming the still image so as not to be recognized (for example, mosaic processing). Alternatively, the hiding of the message may include deleting a video included in the message or preventing the video from being played.

The message server 101 may forcibly remove, from the chatroom, the account of the abusing terminal 104 that transmits, once or a predetermined number or more, the new message matching at least one of the spam keyword 201 and the rule set 202 and thus determined to be an abusing message.

For example, in order to forcibly remove the account of the abusing terminal 104, the message server 101 may determine the forcible removal by itself or need a request for the removal from the administrator terminal 102 or the request for the removal from a certain number of the user terminals 103.

Alternatively, with respect to the abusing terminal 104 transmitting the new message matching at least one of the spam keyword 201 and the rule set 202 and thus determined to be the abusing message, the message server 101 may display the ID of the abusing terminal 104 and the number of abusing messages transmitted by the abusing terminal 104, in a specific area of the chatroom (e.g., an area for notices, such as the top area of the anonymous chatroom, and the profile area of the account corresponding to the abusing terminal), so that the user terminal 103 joining the anonymous chatroom may identify the ID of the abusing terminal 104 and the number of abusing messages transmitted by the abusing terminal 104.

The administrator terminal 102 may manage the list of abusing terminals 104 transmitting the abusing message. In addition, the administrator terminal 102 may forcibly remove the account of the abusing terminal 104 from the anonymous chatroom or cancel the forcible removal. In addition, the administrator terminal 102 may cancel the hiding of the new message determined to be the abusing message and thus hidden.

FIG. 3 is a diagram illustrating an interface providing a function activation for managing an abusing message, according to an embodiment.

According to an embodiment, when a new message created by an abusing terminal 104 is determined to be an abusing message according to a rule set or a spam keyword stored in an administrator terminal 102, the abusing message may be hidden. For such a process, the administrator terminal 102 may activate a filtering function for hiding the abusing message as shown in FIG. 3. An interface for activating the filtering function may be provided to the administrator terminal 102.

The filtering function may be applied to all of anonymous chatrooms managed by the administrator terminal 102 or individually to each of the anonymous chatroom. The administrator terminal 102 may activate or deactivate the filtering function. When the filtering function is activated, the abusive message matching at least one of the rule set and the spam keyword may be hidden. In addition, the account of the abusing terminal 104 transmitting the abusing message may be forcibly removed from (removal) the anonymous chatroom, according to the settings of the administrator terminal 102 of the anonymous chatroom or the settings of a system administrator of the message application.

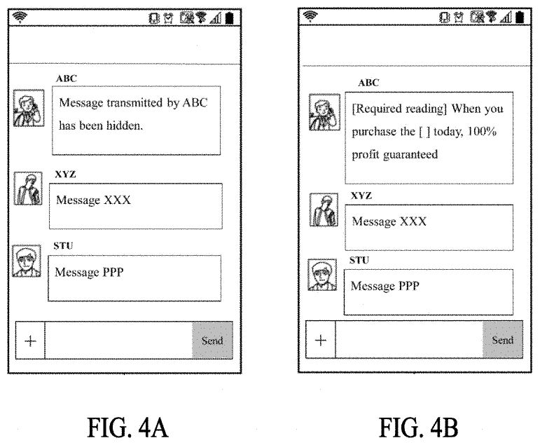

FIGS. 4A and 4B are diagrams illustrating an example of hiding an abusing message according to an embodiment.

When a keyword included in a new message received by an administrator terminal 102 matches at least one of a keyword included in a rule set and a registered spam keyword and is thus determined to be an abusing message, the administrator terminal 102 and a user terminal 103 may hide the new message. FIG. 4A illustrates an example of hiding all details of an abusing message, and FIG. 4B illustrates an example of hiding only some details, corresponding to a spam keyword, of an abusing message.

When all the details of the abusing message are hidden, a speech bubble for the abusing message may be displayed but all the details included in the abusing message may be hidden. In this case, in order to hide the abusing message, the administrator terminal 102 or the user terminal 103 may overlap various types of objects on the top of the abusing message or transform all the details of the abusing message into a form that is difficult to recognize all the details. Alternatively, the administrator terminal 102 or the user terminal 103 may replace all the details of the abusing message with a random combination of letters, symbols, or meaningless keywords and then display the message.

In another embodiment, the administrator terminal 102 or the user terminal 103 may display the speech bubble of the abusing message but display an announcement indicating the result of the hiding, as shown in FIG. 4A, instead of displaying the abusing message. Alternatively, the administrator terminal 102 or the user terminal 103 may not display the speech bubble of the abusing message but may display the hiding of the message transmitted by the abusing terminal 104 by combining the announcement with the object of the chat window (e.g., a shaded box in the form of a square and the like).

In addition, referring to FIG. 4B, when the keyword included in the abusing message matches at least one of the keyword included in the rule set and the spam keyword, only “KK” in the abusing message may be hidden, such as hidden in [ ], and the remaining keywords may be included in the abusing message and thus displayed on the anonymous chatroom. Although not shown in FIG. 4B, “KK” may not be hidden but converted to an arbitrary letter or symbol, or a meaningless keyword (e.g., “aa”), so that the detail of “KK” may be processed in a form that is difficult to recognize.

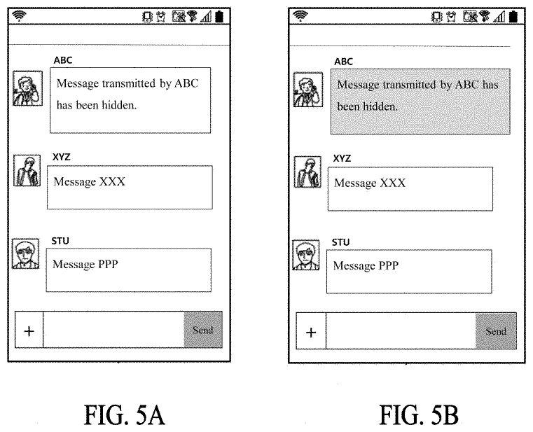

FIGS. 5A and 5B are diagrams illustrating a result of a hiding process distinguished according to a rule set and a spam keyword, according to an embodiment.

FIG. 5A illustrates the result of hiding an abusing message when a new message is determined to be the abusing message by a rule set, and FIG. 5B illustrates the result of hiding an abusing message when a new message is determined to be an abusing message by a spam keyword registered in an administrator terminal 102.

FIGS. 5A and 5B illustrate an embodiment of distinguishing an abusing message determined by the spam keyword registered in the administrator terminal 102 from an abusing message determined by the rule set and then hiding the abusing message in a chat window. According to an embodiment, the form of distinguishing the abusing message according to the spam keyword from the abusing message according to the rule set may be displayed only on the chat window of the administrator terminal 102. However, in the chat window of the user terminal 103, the abusing message may not be distinguished according to the spam keyword from the abusing message according to the rule set but displayed in the same manner.

According to an embodiment, in order to distinguish the abusing message according to the spam keyword from the abusing message according to the rule set, the administrator terminal 102 may display a distinguishment identifier on the abusing message or display the abusing message differently (e.g., highlighting text of the message, changing the size or color of the text, underlining the text, differently setting the shade of a speech bubble, differently displaying the shape or color of the speech bubble, or the like).

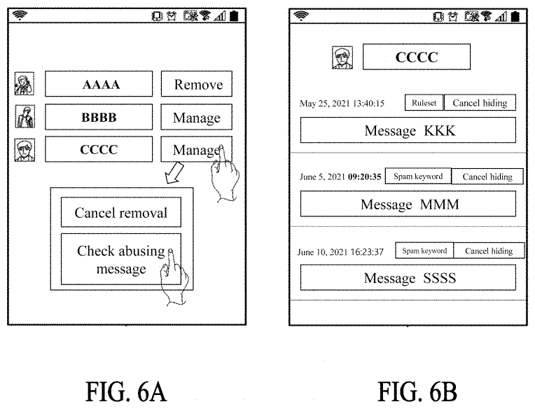

FIGS. 6A and 6B are diagrams illustrating an example of an abusing terminal transmitting an abusing message and an interface for managing the abusing message, according to an embodiment.

Referring to FIGS. 6A and 6B, an interface managed by an administrator terminal 102 is shown, and a list of abusing terminals 104 transmitting an abusing message is displayed on the interface. The abusing terminal 104 may refer to a terminal transmitting an abusing message when a new message transmitted to an anonymous chatroom is determined to be an abusing message according to at least one of a spam keyword and a rule set. According to the present disclosure, even a terminal transmitting an abusing message once may be set as the abusing terminal 104. The administrator terminal 102 may remove (forcibly remove) the account of the abusing terminal 104 of which the ID is AAAA from the anonymous chatroom through the interface shown in FIG. 6A. In this case, when the abusing terminal 104 transmits the abusing message once or by a predetermined number, the account of the abusing terminal 104 may be forcibly removed from the anonymous chatroom.

In addition, when the administrator terminal 102 selects to manage the account of the abusing terminal 104 of which the ID is CCCC in the interface, the administrator terminal 102 may cancel the removal of the account of the abusing terminal 104 that has already been removed from the anonymous chatroom or may check the abusing message that has been hidden with respect to the account of the abusing terminal 104.

When the administrator terminal 102 desires to check the abusing message, the abusing message input to the anonymous chatroom by the abusing terminal 104 of which the ID is CCCC may be displayed in chronological order, as shown in FIG. 6B. Here, a message KKK, a message MMM, and a message SSSS may be abusing messages that have been hidden by the administrator terminal 102, and a cause (spam keyword or rule set) determined to be the abusing message may be displayed by being distinguished by an identifier on the surrounding area of the abusing message. Alternatively, the abusing message may be distinguished from other messages displayed on the chat window in a highlighted form as a whole, such as a highlight or a boldface. In addition, a word that matches at least one of the rule set and the spam keyword in the abusing message may be displayed in the highlighted form, such as a highlight or a boldface, so that the word may be distinguished from other words in the abusing message.

In addition, the administrator terminal 102 may select an abusing message of which the hiding is to be canceled, from among hidden abusing messages. Then, the abusing message that has been hidden may be displayed on the anonymous chatroom. In this case, the abusing message of which hiding has been canceled may be displayed on the anonymous chatroom together with a notification about the cancelation of the hiding of the abusing message. Even when the administrator terminal 102 cancels the hiding of the abusing message, the abusing message may be hidden on the chat window of the user terminal 103 joining the anonymous chatroom.

According to an embodiment, the administrator terminal 102 may manage the abusing message and the abusing terminal 104 transmitting the abusing message, according to the spam keyword or the rule set through an interface separated from the chat window. In addition, the administrator terminal 102 may check the list of hidden abusing messages and the detail of the message and may also cancel the hiding of the abusing message.

The administrator terminal 102 of the anonymous chatroom may register or report the account of the abusing terminal 104 transmitting the abusing message, as an abuser. Then, the message server 101 may manage information about the account of the abusing terminal 104 registered as the abuser. Here, the information about the account of the abusing terminal 104 may include the ID of the abusing terminal 104, the transmission time of the abusing message, the number of abusing messages transmitted, and information about the anonymous chatroom to which the abusing terminal 104 logs in (the name of the chatroom).

The administrator terminal 102 may check all abusing messages transmitted to the anonymous chatroom by the account of the abusing terminal 104 registered as the abuser. In addition, as shown in FIG. 6, the administrator terminal 102 may remove (forcibly remove) the account of the abusing terminal 104 registered as the abuser. The administrator terminal 102 may collectively cancel the hiding of the abusing messages transmitted by the abusing terminal 104, collectively cancel the hiding of only the abusing messages including a certain keyword, or selectively cancel each of the abusing messages.

When the account of the abusing terminal 104 is removed from the anonymous chatroom by the administrator terminal 102 and then desires to re-enter the anonymous chatroom, the account of the abusing terminal 104 may re-enter the anonymous chatroom after the administrator terminal 102 cancels the registration of the account of the abusing terminal 104 as the abuser.

In addition, according to an embodiment, regardless of whether the account of the abusing terminal 104 is registered as the abuser, both of the abusing message hidden by the rule set and the abusing message hidden by the spam keyword may be displayed through the interface. In addition, the abusing messages may be displayed separately for each account of the abusing terminals 104.

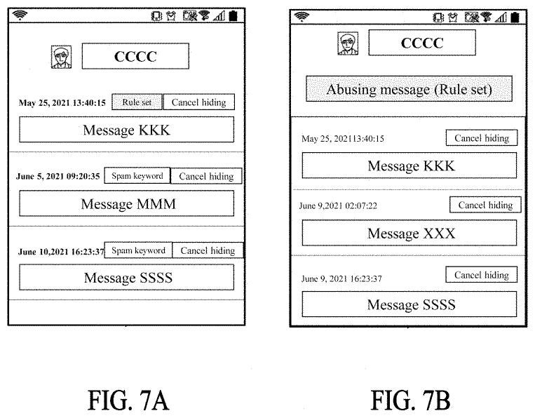

In addition, when a spam keyword registered in the list of spam keywords or a rule registered in the rule set is deleted, all abusing messages hidden by the deleted spam keyword or the deleted rule may be displayed on the chat window of the anonymous chatroom. FIGS. 7A and 7B are diagrams illustrating an example of an interface for managing an abusing message, according to an embodiment.

The description given with reference to FIG. 7A is a case where an administrator terminal 102 manages abusing messages determined according to a spam keyword and a rule set through one interface. The description given with reference to FIG. 7B is a case in which the administrator terminal 102 manages abusing messages determined according to the spam keyword and the rule set through different interfaces.

Referring to FIG. 7A, the administrator terminal 102 may distinguish a message determined to be an abusing message according to a spam keyword from a message determined to be an abusing message according to a rule set and display the determined abusing message differently based on different identifiers or differentiation between display forms in one interface. In this case, the administrator terminal 102 may cancel hiding the abusing message displayed on the interface.

FIG. 7B may be an interface displaying abusing messages transmitted by an abusing terminal 104 of which the account is CCCC, among the abusing messages determined according to the rule set. According to an embodiment, the administrator terminal 102 may manage abusing messages filtered according to the rule set and the spam keyword in one interface or manage abusing messages filtered according to the rule set and the spam keyword in different interfaces. Here, the interface may be set in units of a screen displayed on the administrator terminal 102 and as shown in FIG. 7B, the abusing message filtered according to the rule set and the abusing message filtered according to the spam keyword may be managed through different interfaces.

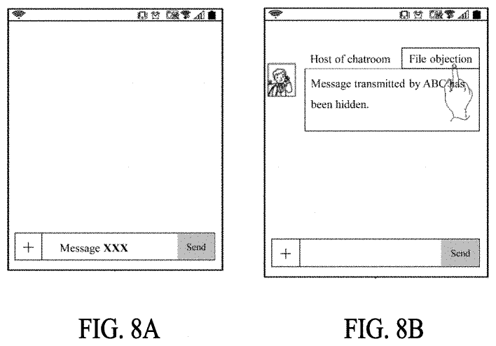

FIGS. 8A and 8B are diagrams illustrating an example of a request for an objection to a hidden abusing message, according to an embodiment.

FIGS. 8A and 8B show chat screens of an abusing terminal 104. When a keyword included in a new message transmitted to an anonymous chatroom matches at least one of a spam keyword and a rule set and thus the new message is determined to be an abusing message, the new message transmitted by the abusing terminal 104 may be hidden in the chat window of the administrator terminal 102 and the chat window of a user terminal 103.

In this case, the abusing terminal 104 may file an objection to the result of hiding the abusing message. As shown in FIG. 8B, a menu for filing an objection may be displayed at the top of an announcement about hiding the abusing message. Alternatively, the menu for objection may not be displayed and the objection may be filed through a certain input (e.g., a long touch) with respect to the announcement or through another menu.

Although not shown in FIG. 8B, in order to identify a cause for a new message created by the abusing terminal 104 to be determined to be an abusing message, a menu capable of checking what detail of the new message matches the rule set or the spam keyword may be provided.

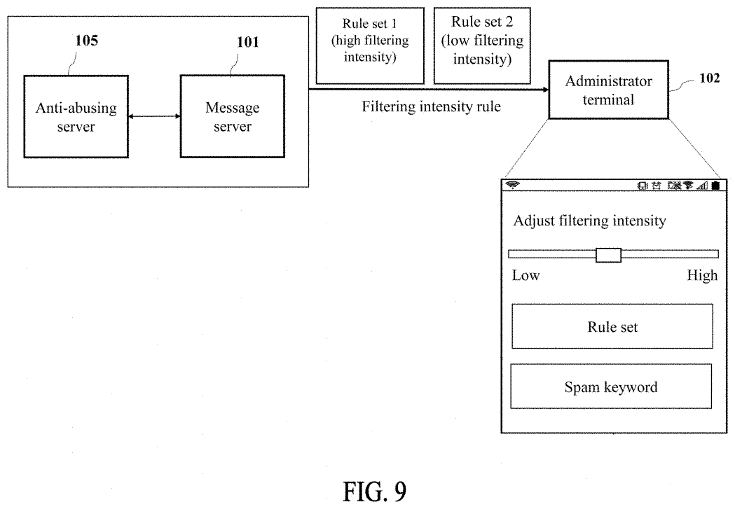

FIG. 9 is a diagram illustrating an interface for adjusting a filtering intensity for an abusing message, according to an embodiment.

Referring to FIG. 9, an administrator terminal 102 may receive a rule set of the latest version when the administrator terminal 102 logs in to an account registered in a message server 101 through a message application or enters an anonymous chatroom. In this case, the administrator terminal 102 may receive a rule set from the message server 101 or an anti-abusing server 105.

According to an embodiment, a filtering intensity may be considered for a rule set and a spam keyword. For example, the message server 101 or the anti-abusing server 105 may distinguish a rule set 1 (related keywords, identifiers, or and the like) with a high filtering intensity from a rule set 2 with a low filtering intensity and provide the rule set 1 and rule set 2 to the administrator terminal 102. Then, the administrator terminal 102 may select the rule set 1 having the “high” filtering intensity or the rule set 2 having the “low” filtering intensity by adjusting the filtering intensity in an interface. In FIG. 9, the number of filtering intensity levels may not be limited to two, and the administrator terminal 102 may continuously adjust the filtering intensity.

In another example, the message server 101 and the anti-abusing server 105 may provide, to the administrator terminal 102, rules for the filtering intensity along with the rule set. For example, the message server 101 and the anti-abusing server 105 may provide, to the administrator terminal 102, a rule for adjusting the filtering intensity corresponding to the number of combined rules, such as the case (the high filtering intensity) in which the message matching only one rule included in the rule set is determined to be an abusing message and the case (the low filtering intensity) in which the message matching two rules or more is determined to be an abusing message.

Similar to the rule set, information about the filtering intensity may also be considered for the spam keyword. Since the spam keyword is registered by the administrator terminal 102, the filtering intensity may be set by the administrator terminal 102. In addition, the administrator terminal 102 may check the rule set or the spam keyword corresponding to the currently set filtering intensity through another interface.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductive wire memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In addition, it should not be understood that the separation of various device components of the aforementioned embodiments is required for all the embodiments, and it should be understood that the aforementioned program components and apparatuses may be integrated into a single software product or packaged into multiple software products.

The embodiments disclosed in the present specification and the drawings are intended merely to present specific embodiments in order to aid in understanding of the present disclosure, but are not intended to limit the scope of the present disclosure. It will be apparent to those skilled in the art that various modifications based on the technical spirit of the present disclosure, as well as the disclosed embodiments, can be made.

What is claimed is:

1. A method of managing an abusing message, performed by an administrator terminal, the method comprising:
storing at least one of a rule set and a spam keyword for an abusing message;
receiving a new message transmitted to an anonymous chatroom;
determining the new message as the abusing message based on the at least one of the rule set and the spam keyword; and
hiding the abusing message in a chat window,
wherein the administrator terminal is configured to set activation of a function for hiding the abusing message through an interface distinguished from the chat window.

2. The method of claim 1, wherein the hiding of the abusing message comprises:
hiding all details of the abusing message matching the at least one of the spam keyword and the rule set; or
hiding some details of the abusing message matching the at least one of the spam keyword and the rule set.

3. The method of claim 2, wherein the hiding of the abusing message comprises:
not displaying all the details of the abusing message in a speech bubble while displaying the speech bubble of the abusing message;
displaying an announcement about the hiding of the abusing message, which replaces all the details of the abusing message in the speech bubble, while displaying the speech bubble of the abusing message; or
displaying an object indicating the hiding of the abusing message without displaying the speech bubble of the abusing message.

4. The method of claim 1, wherein the interface displays, on one common area or on areas distinguished from one another, the abusing message filtered according to the at least one of the rule set and the spam keyword.

5. The method of claim 1, wherein the interface provides a menu that enables the administrator terminal to cancel the hiding of the abusing message filtered according to the at least one of the rule set and the spam keyword and thus hidden.

6. The method of claim 1, wherein the administrator terminal receives the rule set classified according to a filtering intensity or receives a filtering intensity rule related to a combination of rules comprised in the rule set.

7. The method of claim 1, wherein, when the new message is determined to be the abusing message and thus is hidden, the hiding of the abusing message is able to be canceled through filing an objection to the abusing message.

8. An administrator terminal comprising a processor,
wherein the processor is configured to store a rule set or a spam keyword for an abusing message, receive a new message transmitted to an anonymous chatroom and, when the new message is determined to be the abusing message based on the at least one of the rule set and the spam keyword, hide the abusing message in a chat window, and
the administrator terminal is configured to set activation of a function for hiding the abusing message through an interface distinguished from the chat window.

9. The administrator terminal of claim 8, wherein the processor is configured to:
hide all details of the abusing message matching the at least one of the spam keyword and the rule set; or
hide some details of the abusing message matching the at least one of the spam keyword and the rule set.

10. The administrator terminal of claim 9, wherein the processor is configured to:
not display all the details of the abusing message in a speech bubble while displaying the speech bubble of the abusing message;
display an announcement about the hiding of the abusing message, which replaces all the details of the abusing message in the speech bubble, while displaying the speech bubble of the abusing message; or
display an object indicating the hiding of the abusing message without displaying the speech bubble of the abusing message.

11. The administrator terminal of claim 9, wherein the interface is configured to display, on one common area or on areas distinguished from one another, the abusing message filtered according to the at least one of the rule set and the spam keyword.

12. The administrator terminal of claim 9, wherein the interface is configured to provide a menu that enables the administrator terminal to cancel the hiding of the abusing message filtered according to the at least one of the rule set and the spam keyword and thus hidden.

13. The administrator terminal of claim 9, wherein the administrator terminal receives the rule set classified according to a filtering intensity or receives a filtering intensity rule related to a combination of rules comprised in the rule set.

14. The administrator terminal of claim 9, wherein, when the new message is determined to be the abusing message and thus is hidden, the hiding of the abusing message is able to be canceled through filing an objection to the abusing message.
